(19) United States
(12) Patent Application Publication
(10) Pub. No.: US 2022/0314831 A1
(43) Pub. Date: Oct. 6, 2022

(54) GRID SYSTEM, POWER TRANSFERRING AND RECEIVING METHOD, AND STORAGE MEDIUM

(71) Applicant: HONDA MOTOR CO., LTD., Tokyo (JP)

(72) Inventor: Noriyuki Abe, Tokyo (JP)

(21) Appl. No.: 17/679,148

(22) Filed: Feb. 24, 2022

(30) Foreign Application Priority Data
Mar. 31, 2021 (JP) 2021-060323

(51) Int. Cl. B60L 53/63; B60L 55/00; B60L 8/00; H02J 3/32; H02J 7/00; H02J 3/38

(52) U.S. Cl. CPC B60L 53/63; B60L 55/00; B60L 8/003; H02J 3/322; H02J 7/0048; H02J 3/381; H02J 2300/24; H02J 2310/12

(57) ABSTRACT

A grid system in which a first storage battery and a second storage battery can be connected and electric power can be transferred and received between the first storage battery and the second storage battery is provided. The first storage battery is a house storage battery provided in a house and the second storage battery is a vehicle storage battery provided in a vehicle. The grid system includes a power transferring/receiving control unit that adjusts an amount of electric power transferred and received between the first storage battery and the second storage battery; and a function guarantee control unit that performs vehicle function guarantee control for adjusting an amount of electric power transferred and received using the power transferring/receiving control unit to prevent a state of charge (SOC) of the vehicle storage battery from falling below an SOC lower limit value in which a prescribed function of a vehicle in which the vehicle storage battery is installed can be performed while the prescribed function is operating.

### CROSS-REFERENCE TO RELATED APPLICATION

Priority is claimed on Japanese Patent Application No. 2021-060323, filed Mar. 31, 2021, the content of which is incorporated herein by reference.

### BACKGROUND OF THE INVENTION

### Field of the Invention

The present invention relates to a grid system, a power transferring and receiving method, and a storage medium.

### Description of Related Art

In the related art, in home energy management systems (HEMS s), electric vehicles such as electric vehicles (EVs) with a power supply function which include an in-vehicle storage battery and have a function of performing connection to household power supplies (system power supplies) have often not been taken into account.

With regard to electric vehicles, a technique for flexibly utilizing surplus electric power generated using photovoltaic power generation while storing an amount of electric power required for driving an electric vehicle in accordance with a user's applications has been disclosed (for example, refer to Japanese Patent No. 6783411). This technique is a charging/discharging device which charges installed in an electric vehicle with electricity and discharges the storage battery in a house in which a photovoltaic power generation system has been introduced. The charging/discharging device includes an electric power conversion unit which charges with electricity and discharges the storage battery, a charge amount management unit which manages target charge amount information indicating a target amount of charge of the storage battery, a time management unit which manages charge amount adjustment time information indicating a time period during which the storage battery is charged with electricity or discharged to bring an amount of charge of the storage battery closer to the target amount of charge, and an operation control unit which controls the electric power conversion unit on the basis of the target charge amount information and the charge amount adjustment time information.

### SUMMARY OF THE INVENTION

Various inconveniences may occur in many cases when there is no coordination with vehicle charge/discharge control such as requesting discharging even though a state of charge (SOC) of an electric vehicle (EV) is low or requesting charging even when the SOC is high.

When a home energy management system (HEMS) is used in a single-person household or a nuclear family household, and when a user is in a house building and is not in a vehicle, or when a user is in a vehicle and is not in a house building, or the like, it is assumed that the control of an HEMS may be a constraint on energy use in spite of the absence of the user and it is conceivable that uneconomical and inefficient situations will occur.

Although these problems can occur in a situation in which a house such as a house building and a vehicle are connected in a one-to-one correspondence, it is conceivable that this would be noticeable also in a grid system in which vehicles and houses are connected so that energy linkage is possible.

An aspect according to the present invention was made in consideration of such circumstances, and an object of the present invention is to provide a grid system capable of maintaining a prescribed function when electric power is transferred and received, a power transferring and receiving method, and a storage medium.

In order to solve the above problems and achieve the above object, the present invention has adopted the following aspects.

(1): A grid system according to an aspect of the present invention is a grid system in which a first storage battery and a second storage battery are able to be connected and electric power is able to be transferred and received between the first storage battery and the second storage battery, and in which the first storage battery is a house storage battery provided in a house and the second storage battery is a vehicle storage battery provided in a vehicle. The grid system includes: a power transferring/receiving control unit that adjusts an amount of electric power transferred and received between the first storage battery and the second storage battery; and a function guarantee control unit that performs vehicle function guarantee control for adjusting an amount of electric power transferred and received using the power transferring/receiving control unit to prevent a state of charge (SOC) of the vehicle storage battery from falling below an SOC lower limit value in which a prescribed function of a vehicle in which the vehicle storage battery is installed is able to be performed while the prescribed function is operating.

(2): In an aspect of the above (1), the house storage battery may store electric power generated using a photovoltaic power generation apparatus provided in a house, and the vehicle storage battery may store electric power generated using a photovoltaic power generation apparatus provided in a vehicle.

(3): In an aspect of the above (1) or (2), the power transferring/receiving control unit may transfer and receive electric power between a vehicle storage battery of a first consumer and a third storage battery of a second consumer or an intra-regional power line through which a prescribed geographical zone is electrically connected.

(4): In any one of aspects of the above (1) to (3), the function guarantee control unit may prohibit disconnection of a power line connected to the vehicle storage battery while a prescribed function is operating.

(5): In any one of aspects of the above (1) to (4), the function guarantee control unit may set a priority for a plurality of functions on the basis of an operation schedule of prescribed functions of the vehicle.

(6): In an aspect of the above (3), the function guarantee control unit may perform, while a prescribed function is operating in a prescribed geographical zone which is electrically connected through an intra-regional power line, in-grid function guarantee control for adjusting an amount of electric power transferred and received using the power transferring/receiving control unit to prevent an SOC of the second storage battery that supplies electric power to perform the prescribed function from falling below the SOC lower limit value in which the prescribed function is able to be performed.

(7): In an aspect of the above (6), a first intra-regional power line through which a first geographical zone is electrically connected and a second intra-regional power line through which a second geographical zone is electrically connected may be connected, and the function guarantee control unit may perform inter-grid connection maintenance control for maintaining the connection while the first intra-regional power line and the second intra-regional power line are connected.

(8): In an aspect of the above (7), the function guarantee control unit may prioritize the vehicle function guarantee control, the in-grid function guarantee control, and the inter-grid connection maintenance control in this order.

(9): A power transferring and receiving method according to an aspect of the present invention is performed using a grid system in which a first storage battery and a second storage battery are able to be connected and electric power is able to be transferred and received between the first storage battery and the second storage battery, in which the first storage battery is a house storage battery provided in a house and the second storage battery is a vehicle storage battery. The method performed using the grid system includes: adjusting an amount of electric power transferred and received between the first storage battery and the second storage battery; and adjusting an amount of electric power transferred and received in the adjusting of the amount of electric power to prevent an SOC of the vehicle storage battery from falling below an SOC lower limit value in which a prescribed function of a vehicle in which the vehicle storage battery is installed is able to be performed while the prescribed function is operating.

(10): A computer-readable non-transitory storage medium according to an aspect of the present invention stores a computer program for causing a computer to execute: adjusting an amount of electric power transferred and received between a first storage battery that is a house storage battery provided in a house and a second storage battery that is a vehicle storage battery provided in a vehicle; and adjusting an amount of electric power transferred and received in the adjusting of the amount of electric power to prevent an SOC of the vehicle storage battery from falling below an SOC lower limit value in which a prescribed function of a vehicle in which the vehicle storage battery is installed is able to be performed while the prescribed function is operating.

According to (1) to (10), it is possible to maintain a prescribed function when electric power is transferred and received.

### BRIEF DESCRIPTION OF THE DRAWINGS

FIG. 1 is a diagram showing Example 1 of a schematic constitution of a grid system according to an embodiment.

FIG. 2 is a diagram for explaining an example of a house and a vehicle included in the grid system according to the embodiment.

FIG. 3 is a diagram showing an example of an operation of the grid system according to the embodiment.

FIG. 4 is a flowchart for describing an example of the operation of the grid system according to the embodiment.

FIG. 5 is a diagram showing Example 2 of the schematic constitution of the grid system according to the embodiment.

FIG. 6 is a diagram showing Example 3 of the schematic constitution of the grid system according to the embodiment.

FIG. 7 is a diagram showing Example 4 of the schematic constitution of the grid system according to the embodiment.

### DETAILED DESCRIPTION OF THE INVENTION

A grid system and a method performed in the grid system in an embodiment will be described below with reference to the drawings. Embodiments which will be described later are merely examples and embodiments to which the present invention is applied are not limited to the following embodiments. Constituent elements in all drawings for explaining the embodiments that have the same function will be denoted by the same reference numerals and repeated description thereof will be omitted.

The expression “on the basis of XX” mentioned herein means the expression “based on at least XX” and includes a case in which it is based on another element as well in addition to XX. The expression “on the basis of XX” is not limited to a case in which XX is used directly and also include a case in which it is based on something obtained by subjecting XX to calculation or processing. “XX” is an arbitrary element (for example, arbitrary information).

### Embodiment

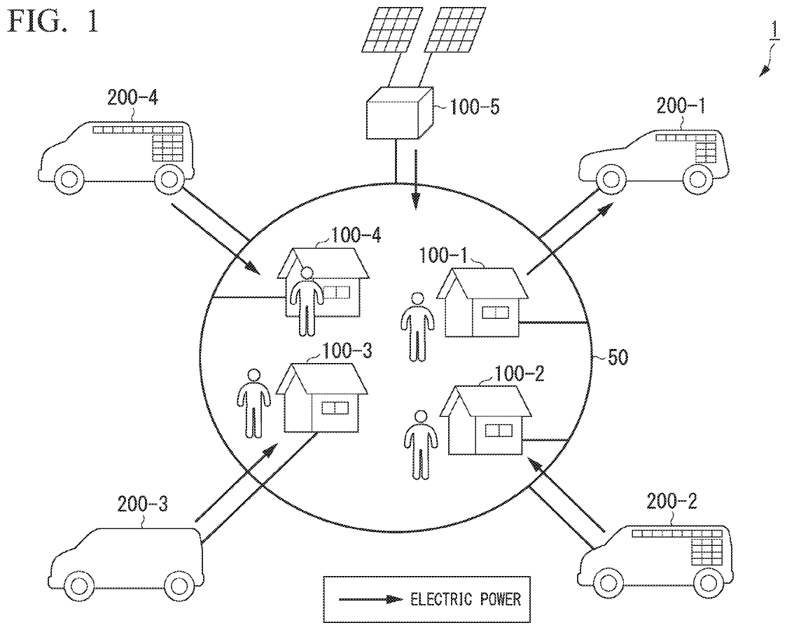

Embodiments of the present invention will be described in detail below with reference to the drawings. FIG. 1 is a diagram showing Example 1 of a schematic constitution of a grid system according to an embodiment.

A grid system 1 according to the embodiment includes an intra-regional power line 50. The intra-regional power line 50 electrically connects a prescribed geographical zone. The intra-regional power line 50 includes a transmission line for mutually accommodating electric power that can be used in a region in each house. A house 100-1 to a house 100-5 are each connected to the intra-regional power line 50 via the power line. Each of the house 100-1 to the house 100-5 receives electric power supplied from the intra-regional power line 50. Each of the house 100-1 to the house 100-5 performs power line carrier communication via the intra-regional power line 50 and the power line.

Grid power supplies electric power to regional transformers (not shown). Each of the regional transformers converters the electric power supplied by the grid power into a voltage and a current suitable for power transmission in the intra-regional power line 50. An example of the voltage and the current in the intra-regional power line 50 is a three-phase three-wire system 200V, a single-phase two-wire system 200V, a single-phase two-wire system 100V, or the like. The regional transformer supplies electric power converted into a voltage and a current suitable for power transmission in the intra-regional power line 50 to the intra-regional power line 50. An example of the intra-regional power line 50 is a circular system, a dendritic system, a low pressure banking system, or a regular network system. In the embodiment, explanation will continue with an example of a case in which the intra-regional power line 50 is a circular system.

Each of the house 100-1 to the house 100-5 includes a photovoltaic power generation apparatus and a house storage battery. The house storage battery stores electric power generated by the photovoltaic power generation apparatus.

The intra-regional power line 50 is constituted so that an electric vehicle (EV) such as an EV and a plug-in hybrid vehicle (PHV) can be connected to the intra-regional power line 50 via the power line. In the example shown in FIG. 1, a vehicle 200-1 is connected to the intra-regional power line 50 in the vicinity of the house 100-1 via the power line, a vehicle 200-2 is connected to the intra-regional power line 50 in the vicinity of the house 100-2 via the power line, a vehicle 200-3 is connected to the intra-regional power line 50 in the vicinity of the house 100-3 via the power line, and a vehicle 200-4 is connected to the intra-regional power line 50 in the vicinity of the house 100-4 via the power line.

Each of the vehicle 200-1 to the vehicle 200-4 includes a vehicle storage battery. Each of the vehicle 200-1, the vehicle 200-2, and the vehicle 200-4 among the vehicle 200-1 to the vehicle 200-4 includes a photovoltaic power generation apparatus. Each of the vehicle 200-1, the vehicle 200-2, and the vehicle 200-4 stores electric power generated by the photovoltaic power generation apparatus in the vehicle storage battery.

When each of the vehicle 200-1 to the vehicle 200-4 is connected to the intra-regional power line 50, it is possible to transfer and receive electric power to and from each of the house 100-1 to the house 100-5 via the intra-regional power line 50 and perform power line carrier communication. When each of the vehicle 200-1 to the vehicle 200-4 transfers and receives electric power to and from each of the house 100-1 to the house 100-5, control is performed to continue performing a prescribed function while the prescribed function is operating.

When each of the vehicle 200-1 to the vehicle 200-4 is connected to the intra-regional power line 50, it is possible to transfer and receive electric power therebetween via the intra-regional power line 50 and to perform power line carrier communication. When each of the vehicle 200-1 to the vehicle 200-4 transfers and receives electric power therebetween, control is performed to continue performing a prescribed function while the prescribed function is operating.

Each of the house 100-1 to the house 100-5 can transfer and receive electric power therebetween via the intra-regional power line 50 and perform power line carrier communication.

Hereinafter, any house among the house 100-1 to the house 100-5 will be referred to as a “house 100.” Any vehicle among the vehicle 200-1 to the vehicle 200-4 will be referred to as a “vehicle 200.” The house 100 and the vehicle 200 will be described in sequence.

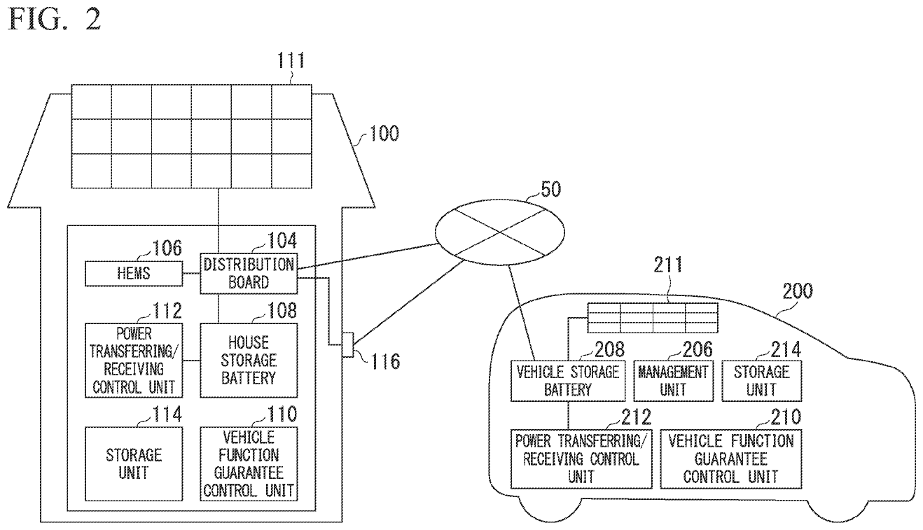

FIG. 2 is a diagram for explaining an example of a house and a vehicle included in the grid system according to the embodiment.

(House 100)

The house 100 includes a distribution board 104, an HEMS 106, a house storage battery 108, a photovoltaic power generation apparatus 111, a power transferring/receiving control unit 112, a storage unit 114, and a joining unit 116.

Grid power supplied from an electric power company is supplied to the distribution board 104 via the regional transformer, the intra-regional power line 50, and the power line. The distribution board 104 supplies electric power supplied from the grid power to a power supply destination. For example, a home appliance (not shown), a housing appliance (not shown), or the like provided in the house 100 is connected to the distribution board 104 as a power supply destination. The distribution board 104 supplies electric power from the grid power to a home appliance, a housing appliance, or the like.

The photovoltaic power generation apparatus 111 and the house storage battery 108 are connected to the distribution board 104. The distribution board 104 supplies electric power generated by the photovoltaic power generation apparatus 111 to the house storage battery 108. The house storage battery 108 stores electric power supplied by the distribution board 104.

The joining unit 116 is connected to the distribution board 104 via a cable. The joining unit 116 can be connected to the intra-regional power line 50 via the power line. The joining unit 116 is a connector that electrically connects the distribution board 104 and the intra-regional power line 50 by being connected to the intra-regional power line 50 using the power line. The connector includes a terminal of the power line through which electric power from the distribution board 104 is supplied to the intra-regional power line 50. The connector includes a terminal of the power line through which electric power supplied from the intra-regional power line 50 is supplied to the distribution board 104. Through the connector, power line carrier communication can be performed between the HEMS 106 and a HEMS 106 installed in in another house connected to the intra-regional power line 50 and a vehicle 200.

When the vehicle 200 is connected to the intra-regional power line 50 via the power line, it is possible to supply electric power stored in the house storage battery 108 of the house 100 to the vehicle 200 via the distribution board 104, the joining unit 116, and the intra-regional power line 50.

When the vehicle 200 is connected to the intra-regional power line 50 via the power line, it is possible to supply electric power stored in the vehicle 200 to the house storage battery 108 of the house 100 via the intra-regional power line 50, the joining unit 116, and the distribution board 104. Here, although the electric power taken out from the vehicle 200 is a direct current (DC), an inverter (not shown) included in the vehicle 200 converts the DC into an alternating current (AC) of 50 Hz or 60 Hz using a single-phase two-wire system 100 V and supplies the AC to the intra-regional power line 50.

Under the control of the HEMS 106, the house storage battery 108 is discharged and the electric power obtained by discharging the house storage battery 108 is supplied to the vehicle 200 via the distribution board 104, the joining unit 116, and the intra-regional power line 50. In the vehicle 200, a vehicle storage battery 208 stores electric power from the intra-regional power line 50.

According to the control of the HEMS 106, the vehicle storage battery 208 of the vehicle 200 is discharged and the electric power obtained by discharging the vehicle storage battery 208 is supplied to the house 100 via the intra-regional power line 50, the joining unit 116, and the distribution board 104. In the house 100, the house storage battery 108 stores electric power from the distribution board 104.

The HEMS 106 acquires information which specifically identifies electric power stored in the house storage battery 108 and information which specifically identifies identification information (hereinafter referred to as a “vehicle storage battery ID”) of the vehicle storage battery 208 and electric power stored in the vehicle storage battery 208. An example of the vehicle storage battery ID is a media access control address (MAC address). A case in which the MAC address is applied will be continued to be explained below as the vehicle storage battery ID.

The HEMS 106 requests that the house storage battery 108 be charged with electricity and requests that the vehicle storage battery 208 corresponding to the vehicle storage battery ID be discharged on the basis of either or both of the acquired information which specifically identifies the electric power stored in the house storage battery 108 and the acquired information which specifically identifies the electric power stored in the vehicle storage battery 208.

Alternatively, the HEMS 106 requests that the house storage battery 108 be discharged and requests that the vehicle storage battery 208 corresponding to the vehicle storage battery ID be charged with electricity on the basis of either or both of the acquired information which specifically identifies the electric power stored in the house storage battery 108 and the acquired information which specifically identifies the electric power stored in the vehicle storage battery 208.

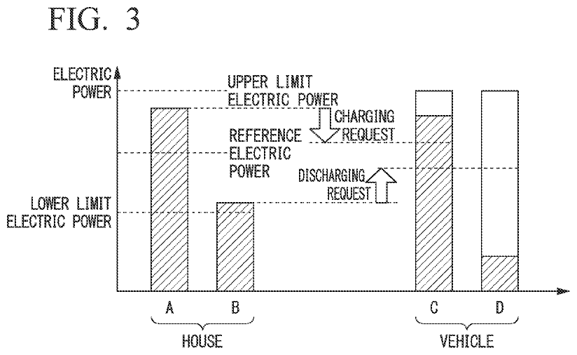

FIG. 3 is a diagram showing an example of an operation of the grid system according to the embodiment.

In FIG. 3, A and B indicate electric power stored in the house storage battery 108 of the house 100 and C and D indicate states of charge (SOC) of the vehicle storage battery 208 of the vehicle 200. The electric power stored in the house storage battery 108 is managed on the basis of lower limit electric power, reference electric power, and upper limit electric power. Here, amounts of electricity stored increase in an order of the lower limit electric power, the reference electric power, and the upper limit electric power. It is preferable that the reference electric power be constant.

A is a case in which an amount of electricity stored is larger than that of the reference electric power and less than that of the upper limit electric power. In this case, the HEMS 106 requests that the house storage battery 108 be discharged and requests that the vehicle storage battery 208 of the vehicle 200 be charged with electricity so as to supply the electric power stored in the house storage battery 108. Thus, the house storage battery 108 is discharged and the electric power obtained by discharging the house storage battery 108 is supplied to the vehicle 200. In the vehicle 200, the vehicle storage battery 208 stores the electric power supplied from the house storage battery 108.

B is a case in which an amount of electricity stored is less than that of the reference electric power and more than that of the lower limit electric power. In this case, the HEMS 106 requests that the house storage battery 108 be charged with electricity and requests that the vehicle storage battery 208 of the vehicle 200 be discharged so as to store the electric power to the house storage battery 108. Thus, the vehicle storage battery 208 is discharged and the electric power obtained by discharging the vehicle storage battery 208 is supplied to the house 100. In the house 100, the house storage battery 108 stores the electric power supplied from the vehicle storage battery 208.

With such a constitution, since the electric power stored in the house storage battery 108 can be supplied to the vehicle storage battery 208 of the vehicle 200 and the electric power supplied to the vehicle storage battery 208 of the vehicle 200 can be supplied to another house storage battery 108, the vehicle 200 can be used as a buffer for electric power. Referring to FIG. 2 again, the explanation will be continued.

The HEMS 106 monitors a current between the joining unit 116 and the intra-regional power line 50 connected to the joining unit 116 and ascertains whether the vehicle storage battery of the vehicle 200 is charged with electricity via the joining unit 116 and the intra-regional power line 50 or the electric power stored in the vehicle storage battery of the vehicle 200 is supplied to the distribution board 104 via the intra-regional power line 50 and the joining unit 116 and the supplied electric power is stored in the house storage battery 108 due to the discharge of the vehicle storage battery of the vehicle 200.

The HEMS 106 is constituted to include a computer and includes, for example, a central processing unit (CPU), a read only memory (ROM), a random access memory (RAM), and an input/output port, and the CPU, the ROM, the RAM, and the input/output port are connected to each other via buses such as an address bus, data bus, and a control bus.

The power transferring/receiving control unit 112 transfers and receives electric power from and to a power transferring/receiving control unit 212 of the vehicle 200. To be specific, the power transferring/receiving control unit 112 supplies the electric power stored in the house storage battery 108 to the vehicle 200. When the electric power stored in the vehicle storage battery 208 of the vehicle 200 is supplied to the house 100, the power transferring/receiving control unit 112 performs control so that the supplied electric power is stored in the house storage battery 108.

The storage unit 114 is realized using a hard disk drive (HDD), a flash memory, a RAM, a ROM, or the like.

The power transferring/receiving control unit 112 is realized using, for example, a hardware processor such as a CPU which executes a computer program (software) stored in the storage unit 114. Some or all of these functional units may be realized using a hardware (circuit unit; including a circuitry) such as a large scale integration (LSI), an application specific integrated circuit (ASIC), a field-programmable gate array (FPGA), and a graphics processing unit (GPU) and may be realized in cooperation of software and hardware. The computer program may be stored in a storage apparatus such as an HDD or a flash memory in advance and may be installed when the computer program is stored in a removable storage medium such as a digital versatile disc (DVD) or a compact disc (CD)-ROM and the storage medium is installed in a drive apparatus.

(Vehicle 200)

A vehicle 200 includes a management unit 206, a vehicle storage battery 208, a function guarantee control unit 210, a photovoltaic power generation apparatus 211, a power transferring/receiving control unit 212, and a storage unit 214.

The management unit 206 acquires information which specifically identifies the electric power stored in the vehicle storage battery 208 and information which specifically identifies identification information (hereinafter referred to as a “house storage battery ID”) of the house storage battery 108 and the electric power stored in the house storage battery 108. An example of the house storage battery ID is a MAC address. A case in which the MAC address is applied will be continued to be explained below as the house storage battery ID.

The management unit 206 requests that the vehicle storage battery 208 be discharged and requests that the house storage battery 108 be charged with electricity on the basis of either or both of the acquired information which specifically identifies the electric power stored in the vehicle storage battery 208 and the acquired information which specifically identifies the electric power stored in the house storage battery 108.

Alternatively, the management unit 206 requests that the vehicle storage battery 208 be charged with electricity and requests that the house storage battery 108 be discharged on the basis of either or both of the acquired information which specifically identifies the electric power stored in the vehicle storage battery 208 and the acquired information which specifically identifies the electric power stored in the house storage battery 108.

The management unit 206 monitors a current between the vehicle storage battery 208 and the intra-regional power line 50 and ascertains whether the vehicle storage battery 208 is charged with electricity or the vehicle storage battery 208 is discharged.

The electric power generated by the photovoltaic power generation apparatus 211 is supplied to the vehicle storage battery 208. The vehicle storage battery 208 stores the electric power supplied by the photovoltaic power generation apparatus 211.

The power transferring/receiving control unit 212 transfers and receives electric power to and from the power transferring/receiving control unit 112 of the house 100. To be specific, the power transferring/receiving control unit 212 supplies the electric power stored in the vehicle storage battery 208 to the house 100. The power transferring/receiving control unit 212 supplies the electric power stored in the house storage battery 108 of the house 100 to the vehicle storage battery 208 of the vehicle 200.

When electric power is transferred and received to and from the house 100 using the power transferring/receiving control unit 212, the function guarantee control unit 210 performs control so that the power transferring/receiving control unit 212 adjusts an amount of electric power transferred and received to prevent an SOC of the vehicle storage battery 208 of the vehicle 200 from falling below an SOC lower limit value in which the prescribed function can be performed while a prescribed function of the vehicle 200 is operating. Hereinafter, performing control so that the amount of electric power transferred and received is adjusted to prevent the SOC of the vehicle storage battery 208 of the vehicle 200 from falling below the SOC lower limit value in which the prescribed function can be performed is referred to as a “vehicle function guarantee control.”

An example of the prescribed function is an important function for protecting the vehicle 200 and includes a function for charging the vehicle storage battery 208 with electricity, a function for discharging the vehicle storage battery 208, and a function for maintaining the security of the vehicle 200. With such a constitution, it is possible to prevent the vehicle storage battery 208 from being unable to be charged with electricity or discharged on the way. It is possible to prevent the problem from occurring due to the reduced security of the vehicle 200.

The storage unit 214 is realized using an HDD, a flash memory, a RAM, a ROM, or the like.

The management unit 206, the function guarantee control unit 210, and the power transferring/receiving control unit 212 are realized by, for example, a hardware processor such as a CPU executing a computer program (software) stored in the storage unit 214. Some or all of these functional units may be realized using hardware (circuit unit; including a circuitry) such as an LSI, an ASIC, an FPGA, a GPU or realized in cooperation with software and hardware. The computer program may be stored in a storage apparatus such as an HDD or a flash memory in advance and may be installed when the computer program is stored in a removable storage medium such as a DVD or a CD-ROM and the storage medium is installed in a drive apparatus.

(Operation of Grid System 1)

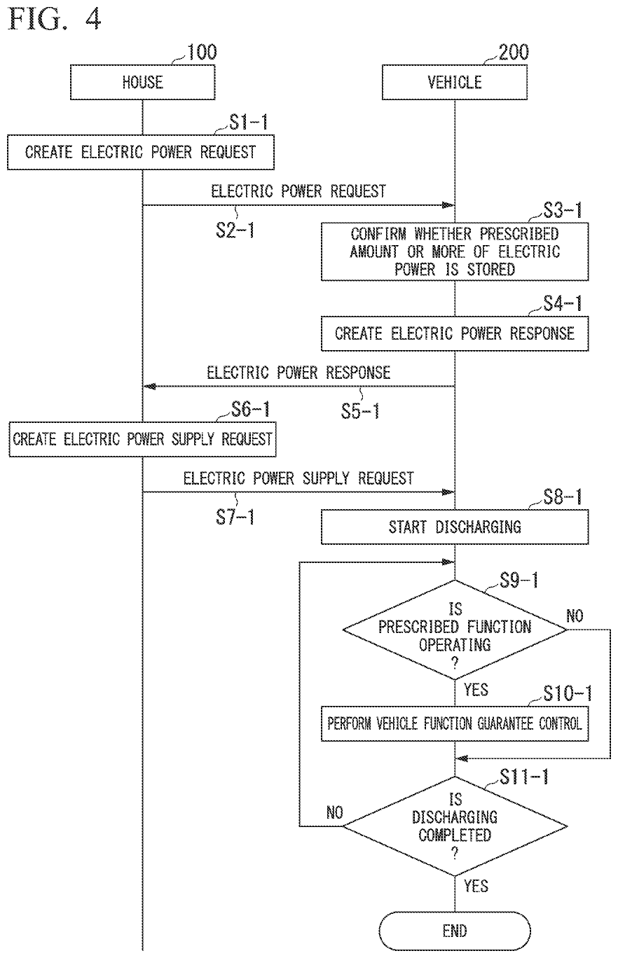

FIG. 4 is a flowchart for describing an example of the operation of the grid system according to the embodiment. As an example, a process of supplying the electric power stored in the vehicle storage battery 208 of the vehicle 200 to the house storage battery 108 of the house 100 will be described.

A case in which, in the house 100, the HEMS 106 acquires information which specifically identifies the electric power stored in the house storage battery 108 and information which specifically identifies a vehicle storage battery ID and the electric power stored in the vehicle storage battery 208 and requests that the vehicle storage battery 208 be discharged and requests that the house storage battery 108 be charged with electricity on the basis of either or both of the acquired information which specifically identifies the electric power stored in the house storage battery 108 and the acquired information which specifically identifies the electric power stored in the vehicle storage battery 208 will be described.

(Step S1-1)

In the house 100, the HEMS 106 creates an electric power request having the vehicle 200 as a destination and including the house storage battery ID and information used for requesting discharging.

(Step S2-1)

In the house 100, the HEMS 106 outputs the created electric power request to the power line. The electric power request output to the power line is transmitted to the vehicle 200 via the distribution board 104, the joining unit 116, and the intra-regional power line 50.

(Step S3-1)

In the vehicle 200, the management unit 206 acquires an electric power request transmitted by the house 100. The management unit 206 acquires information used for requesting discharging included in the acquired electric power request. The management unit 206 acquires information used for specifically identifying the electric power stored in the vehicle storage battery 208 on the basis of the information used for requesting discharging.

The management unit 206 determines whether a prescribed amount or more of electric power is stored in the vehicle storage battery 208 on the basis of the acquired information used for specifically identifying the electric power stored in the vehicle storage battery 208. The management unit 206 determines that the electric power can be supplied through the discharging when it is determined that the electric power stored in the vehicle storage battery 208 is the prescribed amount or more and determines that the electric power cannot be supplied because the discharging cannot be performed when it is determined that the electric power stored in the vehicle storage battery 208 is less than the prescribed amount.

(Step S4-1)

In the vehicle 200, the management unit 206 creates an electric power response including information used for specifically identifying whether electric power can be supplied.

(Step S5-1)

In the vehicle 200, the management unit 206 outputs the created electric power response to the power line. The electric power response output to the power line is transmitted to the house 100 via the intra-regional power line 50, the joining unit 116, and the distribution board 104.

(Step S6-1)

In the house 100, the HEMS 106 acquires the electric power response transmitted by the vehicle 200. The HEMS 106 acquires information used for specifically identifying whether the electric power included in the electric power response can be supplied. Here, a case in which the information used for specifically identifying that the electric power can be supplied is included in the electric power response will be continued to be explained. Here, when the information used for specifically identifying that the electric power cannot be supplied is included in the electric power response, the process returns to the process of Step S1-1 and the management unit 206 may create an electric power request having another vehicle as a destination.

The HEMS 106 starts a process of receiving electric power supplied from the vehicle 200 on the basis of the information used for specifically identifying that the acquired electric power can be supplied. The power transferring/receiving control unit 212 creates an electric power supply request including information used for specifically identifying that the supply of the electric power is received.

(Step S7-1)

In the house 100, the power transferring/receiving control unit 112 outputs the created electric power supply request to the power line. The electric power supply request output to the power line is transmitted to the vehicle 200 via the distribution board 104, the joining unit 116, and the intra-regional power line 50.

(Step S8-1)

In the vehicle 200, the power transferring/receiving control unit 212 acquires the electric power supply request transmitted by the house 100. The power transferring/receiving control unit 212 causes the vehicle storage battery 208 to be discharged on the basis of the acquired electric power supply request. When the vehicle storage battery 208 is discharged, the electric power stored in the vehicle storage battery 208 is supplied to the house storage battery 108 of the house 100 via the intra-regional power line 50, the joining unit 116, and the distribution board 104. The house storage battery 108 stores the supplied electric power.

(Step S9-1)

In the vehicle 200, the function guarantee control unit 210 determines whether a prescribed function is operating. When it is determined that the prescribed function is not operating, the process proceeds to the process of Step S11-1.

(Step S10-1)

In the vehicle 200, when it is determined that the prescribed function is operating, the function guarantee control unit 210 adjusts an amount of electric power supplied to the house 100 by performing discharging to prevent the SOC of the vehicle storage battery 208 from falling below the SOC lower limit value in which the prescribed function can be performed while the prescribed function is operating.

(Step S11-1)

In the vehicle 200, the power transferring/receiving control unit 212 determines whether the discharging is completed. When it is determined that the discharging is not completed, the process returns to the process of Step S9-1 and when it is determined that the discharging is completed, the process ends.

In the flowchart shown in FIG. 4, when the house 100 has a plurality of vehicles capable of transmitting an electric power request, the HEMS 106 may determine a vehicle to which the HEMS 106 transmits an electric power request on the basis of determination concerning whether each of the plurality of vehicles includes a photovoltaic power generation apparatus. In this case, the vehicle 200 transmits information used for specifically identifying whether to include the photovoltaic power generation apparatus in advance to the house 100.

To be specific, the HEMS 106 may prioritize a vehicle including a photovoltaic power generation apparatus compared with a vehicle which does not include a photovoltaic power generation apparatus. With such a constitution, when a plurality of vehicles which can receive an electric power request transmitted by the house 100 are provided, a right to preferentially supply electric power can be provided to a vehicle including a photovoltaic power generation apparatus. Thus, it is possible to promote the vehicle 200 to include a photovoltaic power generation apparatus.

Although a case in which the HEMS 106 requests that the house storage battery 108 be charged with electricity and requests that the vehicle storage battery 208 be discharged has been described with reference to FIG. 4 as an example, a case in which the HEMS 106 requests that the house storage battery 108 be discharged and requests that the vehicle storage battery 208 be charged with electricity can also be applied.

Although a case in which the house 100 and the vehicle 200 are connected through the power line and the power line carrier communication is performed through the power line has been described in the embodiment described above, the present invention is not limited to this example. For example, communication may be performed between the house 100 and the vehicle 200 using an information line or wireless communication may be performed.

Although a case in which the vehicle storage battery 208 of the vehicle 200 receives electric power supplied via a cable has been described in the embodiment described above, the present invention is not limited to this example. For example, the intra-regional power line 50 and the vehicle 200 may be electrically connected in a non-contact manner such that electric power is supplied from the house 100 and the vehicle storage battery 208 is charged with electricity.

To be specific, a power transferring/receiving circuit (not shown) including a coil is provided in a parking space or the like and the power transferring/receiving circuit is connected to the distribution board 104 via the intra-regional power line 50. The vehicle 200 includes the power transferring/receiving circuit including a coil and the power transferring/receiving circuit is connected to the vehicle storage battery 208.

When the vehicle storage battery 208 is charged with electricity, electric power is supplied to the coil on the vehicle side through an electromagnetic induction action and the vehicle storage battery 208 is charged with electricity via the power transferring/receiving circuit by supplying electric power from the distribution board 104 to the power transferring/receiving circuit on the parking space side and causing electricity to be conducted through the coil.

When electric power is supplied from the vehicle storage battery 208, electric power is supplied to the coil on the parking space side through an electromagnetic induction action and the electric power is supplied to the distribution board 104 via the power transferring/receiving circuit by causing electricity to be conducted through the coil on the vehicle side using the electric power of the vehicle storage battery 208.

In the embodiment described above, the function guarantee control unit 210 prohibits the disconnection of the power line connected to the vehicle storage battery 208 during execution of vehicle function guarantee control. For example, the connection between the function guarantee control unit 210 and the power line may be locked so that the power line is not separated from the vehicle storage battery 208. With such a constitution, it is possible to prevent the power line from being separated and being unable to transfer and receive electric power during execution of vehicle function guarantee control, in other words, while electric power is being transferred and received.

In the embodiment described above, the function guarantee control unit 210 may adjust an amount of electric power transferred and received to prevent the SOC of the vehicle storage battery 208 which supplies electric power to perform the prescribed function from falling below the SOC lower limit value in which the prescribed function can be performed while a prescribed function is operating in a prescribed geographical zone which is electrically connected through the intra-regional power line 50.

Hereinafter, performing control for adjusting the amount of electric power transferred and received to prevent the SOC of the vehicle storage battery 208 which supplies electric power to perform the prescribed function from falling below the SOC lower limit value in which the prescribed function can be performed while the prescribed function is operating in the prescribed geographical zone which is electrically connected through the intra-regional power line 50 is “in-grid function guarantee control.”

Here, an example of the prescribed function operating in the prescribed geographical zone which is electrically connected through the intra-regional power line 50 may relate to life support or the like. To be specific, an example of the prescribed function includes electric power used for an operation of an elevator and during important meetings. With such a constitution, when the electric power stored in the vehicle storage battery 208 of the vehicle 200 is used as a power source, it is possible to prevent the vehicle 200 from being separated from the intra-regional power line 50, being unable to supply electric power, and being unable to perform a prescribed function.

Although a case in which electric power is transferred and received between each of the house 100-1 to the house 100-4 connected to the intra-regional power line 50 and each of the vehicle 200-1 to the vehicle 200-4 has been described in the embodiment described above, the present invention is not limited to this example.

For example, the vehicle 200 may acquire external grid electric power for the purpose of using the external grid electric power inside the intra-regional power line 50 and supply the acquired external grid electric power to the intra-regional power line 50. Here, the external grid electric power is electric power supplied to the intra-regional power line 50 from another intra-regional power line through which a geographical zone different from the prescribed geographical zone which is connected through the intra-regional power line 50 is electrically connected.

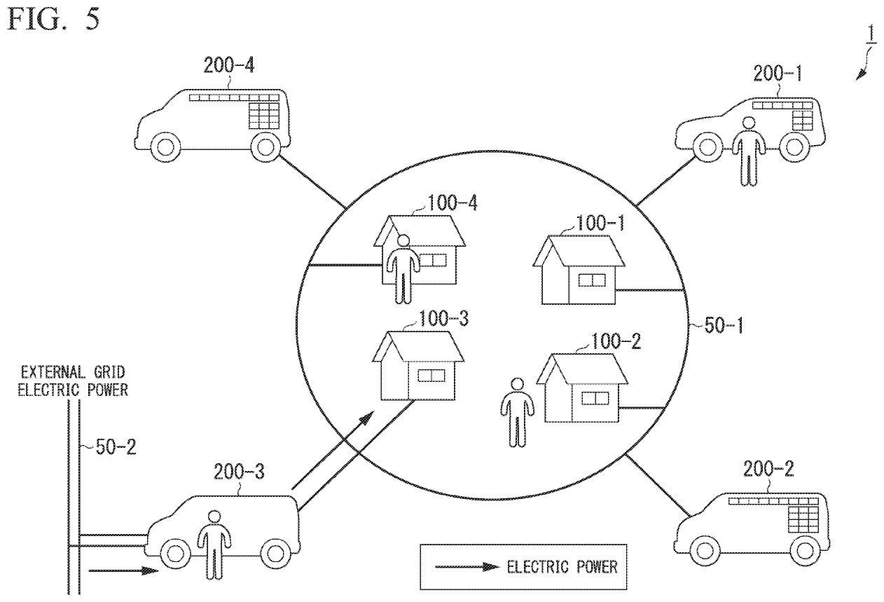

FIG. 5 is a diagram showing Example 2 of the schematic constitution of the grid system according to the embodiment. A house 100-1 to a house 100-4 each are connected to a first intra-regional power line 50-1 and receive electric power supplied from the first intra-regional power line 50-1. A vehicle 200-1 is connected to the first intra-regional power line 50-1 in the vicinity of the house 100-1, a vehicle 200-2 is connected to the first intra-regional power line 50-1 in the vicinity of the house 100-2, a vehicle 200-3 is connected to the first intra-regional power line 50-1 in the vicinity of the house 100-3, and a vehicle 200-4 is connected to the first intra-regional power line 50-1 in the vicinity of the house 100-4.

The vehicle 200-3 of the vehicle 200-1 to the vehicle 200-4 is connected to a second intra-regional power line 50-2 in addition to the first intra-regional power line 50-1. The vehicle 200-3 stores the external grid electric power supplied from the second intra-regional power line 50-2 in a vehicle storage battery 208. The vehicle 200-3 can supply the electric power stored in the vehicle storage battery 208 to the first intra-regional power line 50-1. The electric power supplied to the first intra-regional power line 50-1 using the vehicle 200-3 can be supplied to any of the house 100-1 to the house 100-4, the vehicle 200-1, the vehicle 200-2, and the vehicle 200-4 which are connected to the first intra-regional power line 50-1.

In other words, the vehicle 200-3 relays electric power between the first intra-regional power line 50-1 and the second intra-regional power line 50-2. The vehicle 200-3 supplies the external grid electric power stored in the vehicle storage battery 208 to the first intra-regional power line 50-1. The external grid electric power is supplied to the second intra-regional power line 50-2 to the first intra-regional power line 50-1 via a relay apparatus such as the vehicle 200-3.

In this case, the function guarantee control unit 210 maintains the connection while the vehicle storage battery 208 is being connected to the first intra-regional power line 50-1 and the second intra-regional power line 50-2. Hereinafter, performing control for maintaining the connection while the vehicle storage battery 208 is being connected to the first intra-regional power line 50-1 and the second intra-regional power line 50-2 is referred to as “grid-to-grid connection position control.”

In the embodiment described above, when an operation schedule of a prescribed function is set in the vehicle 200, the function guarantee control unit 210 may set a priority for a plurality of functions on the basis of the operation schedule of the prescribed function of the vehicle 200. With such a constitution, it is possible to guarantee the execution of a prescribed function on the basis of the priority of the plurality of functions set based on the operation schedule of the vehicle 200.

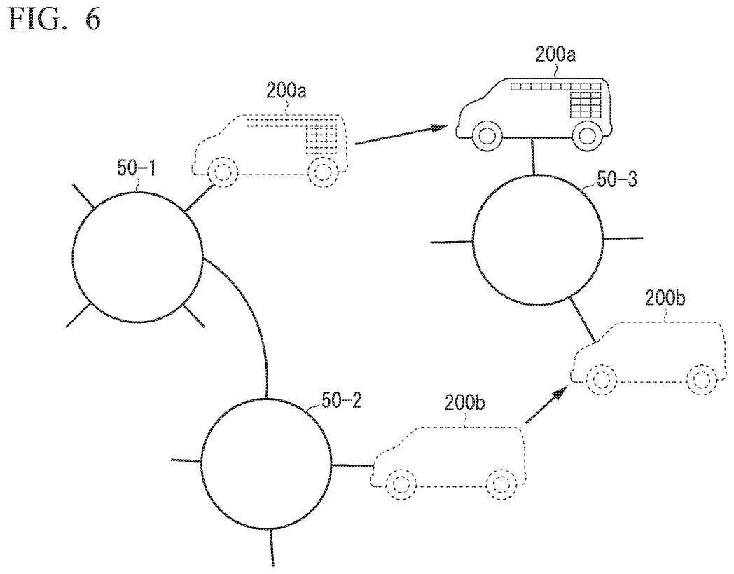

In the embodiment described above, the vehicle 200 may be used for transferring electric power. FIG. 6 is a diagram showing Example 3 of the schematic constitution of the grid system according to the embodiment. FIG. 6 shows the first intra-regional power line 50-1, the second intra-regional power line 50-2, and a third intra-regional power line 50-3.

The vehicle 200 described above can be applied as a vehicle 200a. The vehicle 200a connected to the first intra-regional power line 50-1 receives electric power supplied via the first intra-regional power line 50-1 and the supplied electric power is stored in the vehicle storage battery 208. After that, the vehicle 200a moves, is connected to the third intra-regional power line 50-3, and supplies electric power to the third intra-regional power line 50-3. With such a constitution, the vehicle 200a can be used to transfer electric power from a prescribed geographical zone connected through the first intra-regional power line 50-1 to a prescribed geographical zone connected through the third intra-regional power line 50-3.

Also, the vehicle 200 described above can be applied as a vehicle 200b. The vehicle 200b connected to the second intra-regional power line 50-2 receives electric power supplied via the second intra-regional power line 50-2 and the supplied electric power is stored in the vehicle storage battery 208. After that, the vehicle 200b moves, is connected to the third intra-regional power line 50-3, and supplies electric power to the third intra-regional power line 50-3. With such a constitution, the vehicle 200b can be used to transfer electric power from a prescribed geographical zone connected through the second intra-regional power line 50-2 to a prescribed geographical zone connected through the third intra-regional power line 50-3.

In the prescribed geographical zone connected through the third intra-regional power line 50-3, it is possible to receive electric power transferred and supplied using the vehicle 200a and electric power transferred and supplied using the vehicle 200b.

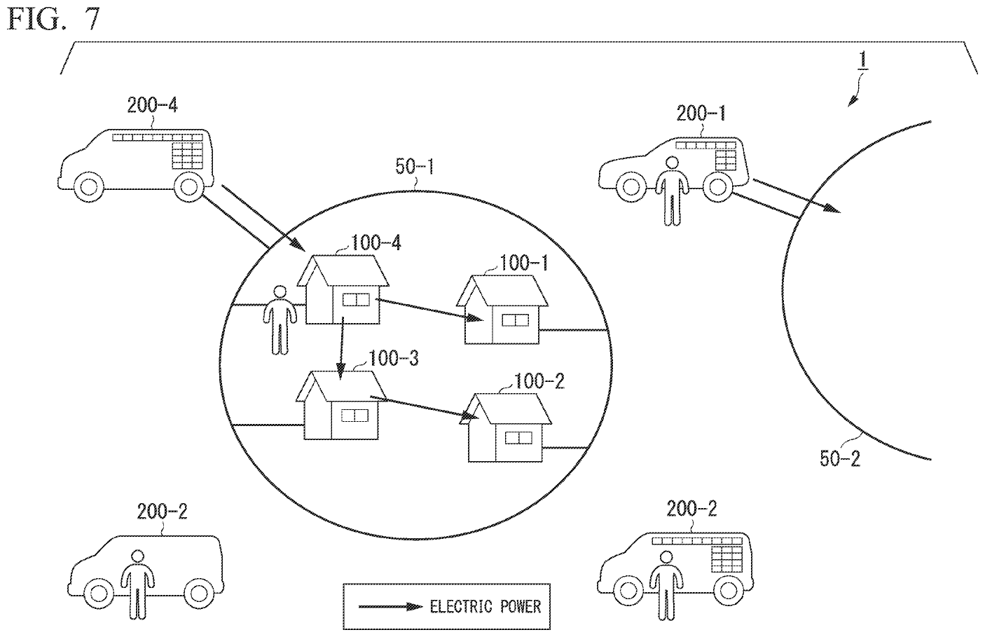

FIG. 7 is a diagram showing Example 4 of the schematic constitution of the grid system according to the embodiment. FIG. 7 shows a first intra-regional power line 50-1 and a second intra-regional power line 50-2. A house 100-1 to a house 100-4 are connected to the first intra-regional power line 50-1 via a power line. A vehicle 200-1 is connected to the second intra-regional power line 50-2 via a power line.

For example, the vehicle 200-1 receives electric power supplied via the first intra-regional power line 50-1, the supplied electric power is stored in a vehicle storage battery 208, and then the vehicle 200-1 moves to a prescribed geographical zone connected through the second intra-regional power line 50-2. In this case, when the vehicle 200-1 is connected to the second intra-regional power line 50-2, the vehicle 200-1 can supply electric power to the second intra-regional power line 50-2.

When vehicle function guarantee control, in-grid function guarantee control, and grid-to-grid connection position control are performed, a function guarantee control unit 210 may prioritize and perform the vehicle function guarantee control, the in-grid function guarantee control, and the grid-to-grid connection position control. To be specific, the function guarantee control unit 210 may perform the vehicle function guarantee control with the highest priority, the in-grid function guarantee control with the next priority, and the grid-to-grid connection position control with the next priority in this order.

According to the grid system 1 associated with the embodiment, a first storage battery and a second storage battery can be connected to the grid system 1 and electric power can be transferred and received between the first storage battery and the second storage battery. The first storage battery is a house storage battery 108 provided in a house 100 and the second storage battery is a vehicle storage battery 208 provided in a vehicle 200.

The grid system 1 includes a power transferring/receiving control unit (112, 212) that adjusts an amount of electric power transferred and received between the first storage battery and the second storage battery and a function guarantee control unit 210 that performs vehicle function guarantee control for adjusting an amount of electric power transferred and received using the power transferring/receiving control unit (112, 212) to prevent an SOC of the vehicle storage battery 208 from falling below an SOC lower limit value in which a prescribed function of the vehicle 200 in which the vehicle storage battery 208 is installed can be performed while the prescribed function is operating.

With such a constitution, since the amount of electric power transferred and received using the power transferring/receiving control unit (112, 212) is adjusted to prevent the SOC of the vehicle storage battery 208 from falling below the SOC lower limit value in which the prescribed function can be performed while electric power is being transferred and received between the first storage battery and the second storage battery, it is possible to guarantee the execution of the prescribed function of the vehicle 200.

The house storage battery 108 stores the electric power generated using the photovoltaic power generation apparatus 111 provided in the house 100 and the vehicle storage battery 208 stores the electric power generated using the photovoltaic power generation apparatus 211 provided in the vehicle 200. With such a constitution, also in the case of the house 100 and the vehicle 200 including a photovoltaic power generation apparatus whose SOC is easily affected by the weather and has a large influence of the weather, it is possible to guarantee the execution of a prescribed function of the vehicle 200.

The power transferring/receiving control unit (112, 212) transfers and receives electric power between the vehicle storage battery 208 of a first consumer and a third storage battery of a second consumer or an intra-regional power line through which a prescribed geographical zone is electrically connected. With such a constitution, other consumers and grids can be used to guarantee the execution of prescribed functions of the vehicle 200.

The function guarantee control unit 210 prohibits the disconnection of the power line connected to the vehicle storage battery 208 while a prescribed function is operating. With such a constitution, it is possible to prevent the power line from being separated and being unable to transfer and receive electric power during execution of vehicle function guarantee control.

The function guarantee control unit 210 sets the priority for a plurality of functions on the basis of an operation schedule of a prescribed function of the vehicle 200. With such a constitution, it is possible to guarantee the execution of the prescribed function of the vehicle 200 on the basis of the priority of the prescribed function in the vehicle.

The function guarantee control unit 210 performs the in-grid function guarantee control for adjusting an amount of electric power transferred and received using the power transferring/receiving control unit to prevent the SOC of the second storage battery which supplies electric power for performing a prescribed function from falling below the SOC lower limit value in which the prescribed function can be performed while the prescribed function is operating in a prescribed geographical zone which is electrically connected through the intra-regional power line 50. With such a constitution, since the amount of electric power transferred and received using the power transferring/receiving control unit is adjusted to prevent the SOC of the second storage battery from falling below the SOC lower limit value while a prescribed function is operating, it is possible to guarantee the use of a prescribed function in the grid.

The first intra-regional power line 50-1 through which a first geographical zone is electrically connected and the second intra-regional power line 50-2 through which a second geographical zone is electrically connected are connected and the function guarantee control unit 210 performs inter-grid connection maintenance control for maintaining the connection while the first intra-regional power line 50-1 and the second intra-regional power line 50-2 are being connected. With such a constitution, it is possible to maintain cooperation (connection) between a plurality of grids.

The function guarantee control unit 210 prioritizes vehicle function guarantee control, in-grid function guarantee control, and inter-grid connection maintenance control in this order. With such a constitution, it is possible to guarantee the execution of a prescribed function on the basis of the priority of each function guarantee.

Although the aspects for carrying out the present invention have been described above using the embodiments, the present invention is not limited to these embodiments and various modifications and substitutions are possible without departing from the gist of the present invention.

What is claimed is:

1. A grid system in which a first storage battery and a second storage battery are able to be connected and electric power is able to be transferred and received between the first storage battery and the second storage battery,
in which the first storage battery is a house storage battery provided in a house and the second storage battery is a vehicle storage battery provided in a vehicle, the grid system comprising:
a power transferring/receiving control unit that adjusts an amount of electric power transferred and received between the first storage battery and the second storage battery; and
a function guarantee control unit that performs vehicle function guarantee control for adjusting an amount of electric power transferred and received using the power transferring/receiving control unit to prevent a state of charge (SOC) of the vehicle storage battery from falling below an SOC lower limit value in which a prescribed function of a vehicle in which the vehicle storage battery is installed is able to be performed while the prescribed function is operating.

2. The grid system according to claim 1, wherein the house storage battery stores electric power generated using a photovoltaic power generation apparatus provided in a house, and
the vehicle storage battery stores electric power generated using a photovoltaic power generation apparatus provided in a vehicle.

3. The grid system according to claim 1, wherein the power transferring/receiving control unit transfers and receives electric power between a vehicle storage battery of a first consumer and a third storage battery of a second consumer or an intra-regional power line through which a prescribed geographical zone is electrically connected.

4. The grid system according to claim 1, where the function guarantee control unit prohibits disconnection of a power line connected to the vehicle storage battery while a prescribed function is operating.

5. The grid system according to claim 1, wherein the function guarantee control unit sets a priority for a plurality of functions on the basis of an operation schedule of a prescribed function of the vehicle.

6. The grid system according to claim 3, wherein the function guarantee control unit performs, while a prescribed function is operating in a prescribed geographical zone which is electrically connected through the intra-regional power line, in-grid function guarantee control for adjusting an amount of electric power transferred and received using the power transferring/receiving control unit to prevent an SOC of the second storage battery that supplies electric power to perform the prescribed function from falling below the SOC lower limit value in which the prescribed function is able to be performed.

7. The grid system according to claim 6, wherein a first intra-regional power line through which a first geographical zone is electrically connected and a second intra-regional power line through which a second geographical zone is electrically connected are connected, and
the function guarantee control unit performs inter-grid connection maintenance control for maintaining the connection while the first intra-regional power line and the second intra-regional power line are connected.

8. The grid system according to claim 7, wherein the function guarantee control unit prioritizes the vehicle function guarantee control, the in-grid function guarantee control, and the inter-grid connection maintenance control in this order.

9. A power transferring and receiving method performed using a grid system in which a first storage battery and a second storage battery are able to be connected and electric power is able to be transferred and received between the first storage battery and the second storage battery, and
in which the first storage battery is a house storage battery provided in a house and the second storage battery is a vehicle storage battery, the method performed using the grid system comprising:
adjusting an amount of electric power transferred and received between the first storage battery and the second storage battery; and
adjusting an amount of electric power transferred and received in the adjusting of the amount of electric power to prevent an SOC of the vehicle storage battery from falling below an SOC lower limit value in which a prescribed function of a vehicle in which the vehicle storage battery is installed is able to be performed while the prescribed function is operating.

10. A computer-readable non-transitory storage medium for storing a computer program causing a computer to execute:
adjusting an amount of electric power transferred and received between a first storage battery that is a house storage battery provided in a house and a second storage battery that is a vehicle storage battery provided in a vehicle; and
adjusting an amount of electric power transferred and received in the adjusting of the amount of electric power to prevent an SOC of the vehicle storage battery from falling below an SOC lower limit value in which a prescribed function of a vehicle in which the vehicle storage battery is installed is able to be performed while the prescribed function is operating.
